(19) United States
(12) Patent Application Publication
(10) Pub. No.: US 2011/0283500 A1
(43) Pub. Date: Nov. 24, 2011

(54) SYSTEM AND TOOL FOR REMOVING BATTERY CAPS

(76) Inventor: Murray P. Velkow, Toronto (CA)

(21) Appl. No.: 12/784,582

(22) Filed: May 21, 2010

(51) Int. Cl. B23P 19/04

(52) U.S. Cl. 29/240

(57) ABSTRACT

A tool for removing a battery cap having a sidewall and finger grip tabs, comprises a handle affixed to a socket comprising a plurality of recesses extending from the floor of the socket toward the opening of the socket. A plurality of pinch projections extending from a floor of the socket partway toward an opening of the socket form second sets of recesses respectively underlying first sets of recesses, the first and second sets of recesses having different shapes or dimensions or both. A plurality of different designs and configurations of cap can thereby be lodged and rotationally fixed within the socket to remove the cap from and replace the cap, for example on a battery cell.

### FIELD OF THE INVENTION

This invention relates to tools. In particular, this invention relates to a safety tool for removing the vented caps from rechargeable lead acid batteries.

### BACKGROUND OF THE INVENTION

Many types of equipment use rechargeable lead acid batteries, including electric vehicles. Some types of electric vehicles, particularly those designed for indoor use, for example fork lift trucks, run entirely on one or more rechargeable lead acid battery. For such vehicles, it is imperative that the batteries be properly maintained, for the continued safe and effective operation of the vehicle.

Part of a proper maintenance and inspection program for such batteries is the maintenance and inspection of water levels within the battery. For this purpose, a rechargeable lead acid battery is provided with removable vented caps for each of these separate compartments or “cells” containing a mixture of electrolyte and water fluids.

However, since the fluid in the battery cell is corrosive, the manual removal of such battery caps is a potentially hazardous chore. Furthermore, the repercussions of failing to maintain adequate fluid levels in a battery are not immediately apparent. For these reasons, workers often fail to maintain regularly scheduled fluid top-ups for batteries used in fork lift trucks and the like. This results in a reduction in the efficiency of the battery and, in extreme cases, damage to the battery and/or the vehicle's related electrical components.

There is therefore a need for a tool which can be used to safely and easily remove such battery caps. However, there are many different standard “designs” of battery caps, and it is not practical or desirable to maintain multiple tools for this purpose.

### BRIEF DESCRIPTION OF THE DRAWINGS

In drawings which illustrate by way of example only a preferred embodiment of the invention,

FIG. 1 is a side elevation of a tool according to the invention.

FIG. 2 is a front cross sectional elevation of the tool of FIG. 1.

FIG. 3 is a bottom plan view of the tool of FIG. 1.

FIG. 4 is a partial bottom perspective view of the socket in the tool of FIG. 1.

FIG. 5 is an enlarged fragmentary bottom plan view of the recess in the socket of FIG. 4.

FIGS. 6A and 6B are top plan and elevational views, respectively, of a first cap removable and replaceable by the tool of the invention;

FIG. 6C is a bottom cross-sectional view of the tool showing the pinch points of the tool against the cap of FIGS. 6A and 6B.

FIGS. 7A and 7B are top plan and elevational views, respectively, of a second cap removable and replaceable by the tool of the invention;

FIG. 7C is a bottom cross-sectional view of the tool showing the pinch points of the tool against the cap of FIGS. 7A and 7B.

FIGS. 8A and 8B are top plan and elevational views, respectively, of a first cap removable and replaceable by the tool of the invention;

FIG. 8C is a bottom cross-sectional view of the tool showing the pinch points of the tool against the cap of FIGS. 8A and 8B.

FIGS. 9A and 9B are top plan and elevational views, respectively, of a first cap removable and replaceable by the tool of the invention;

FIG. 9C is a bottom cross-sectional view of the tool showing the pinch points of the tool against the cap of FIGS. 9A and 9B.

### DETAILED DESCRIPTION OF THE INVENTION

In one embodiment the invention provides tool for removing a cap from a battery cell, the cap having a sidewall and radially extending tabs, comprising: a handle affixed to a socket, the socket comprising a plurality of recesses extending from the floor of the recesses to the opening of the socket, a plurality of pinch projections associated with said recesses, said pinch projections extending from a floor of the socket partway toward an opening of the socket and into a central portion of the socket forming second sets of recesses respectively underlying first sets of recesses, the first and second sets of recesses having different shapes or dimensions or both, whereby a plurality of different configurations of cap can be lodged and rotationally fixed within the socket to remove said cap from the battery cell.

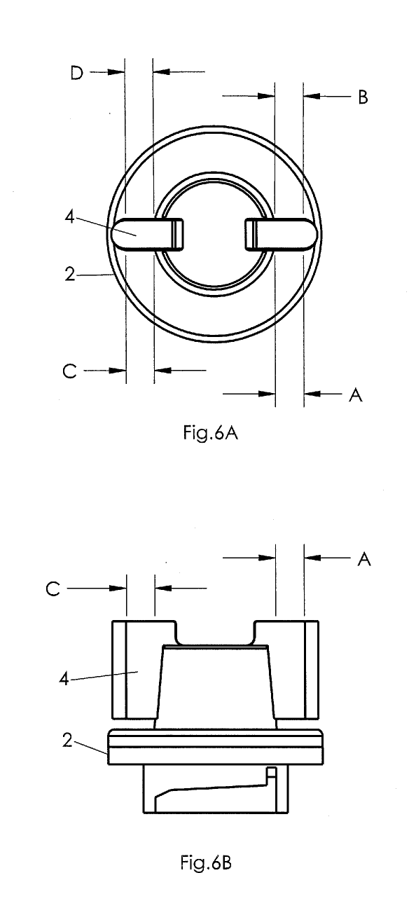

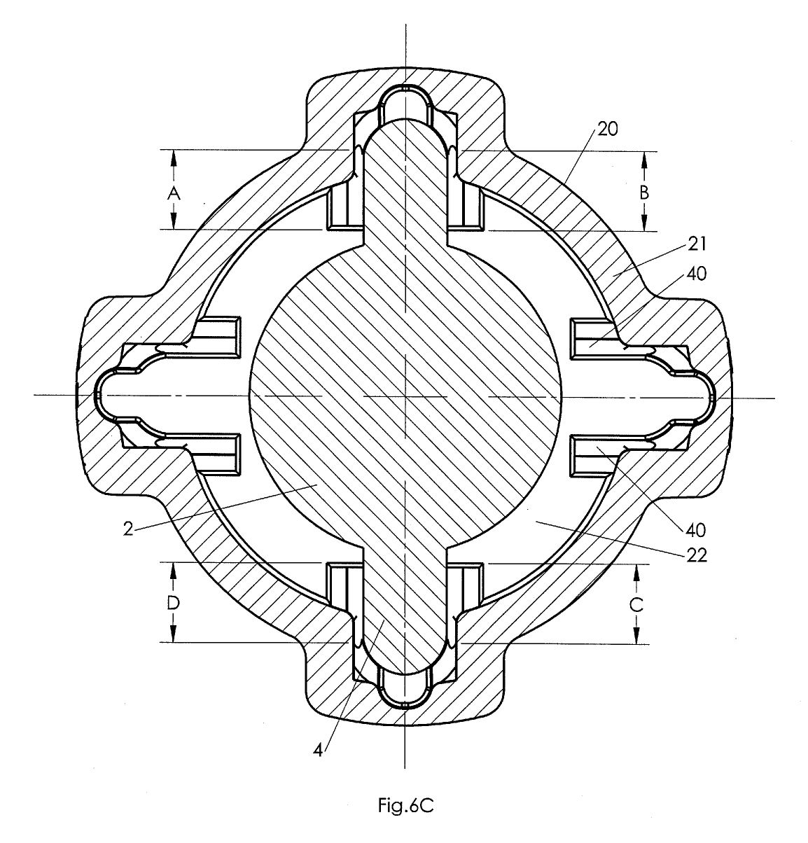

A typical battery (not shown) provides a series of separate compartments or “cells” containing a liquid electrolyte and water mixture. The opening to each cell is covered by a quarter turn screw down vented cap 2. The vented cap 2 may be provided with two or four radially extending finger grip tabs 4, to facilitate manual rotation for removal and replacement of the vented cap 2. Examples of standard battery caps are illustrated in FIGS. 6A, 6B, 7A, 7B, 8A, 8B and 9A, 9B.

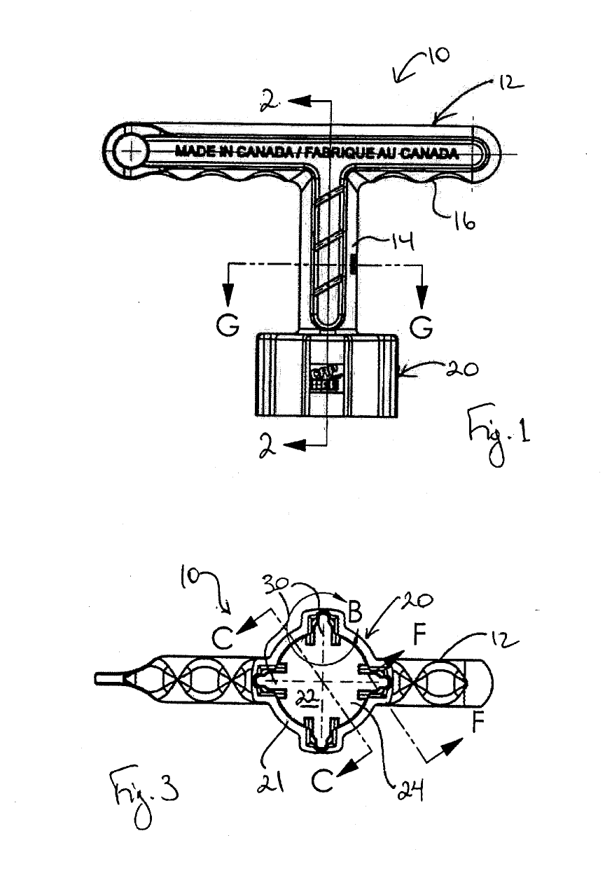

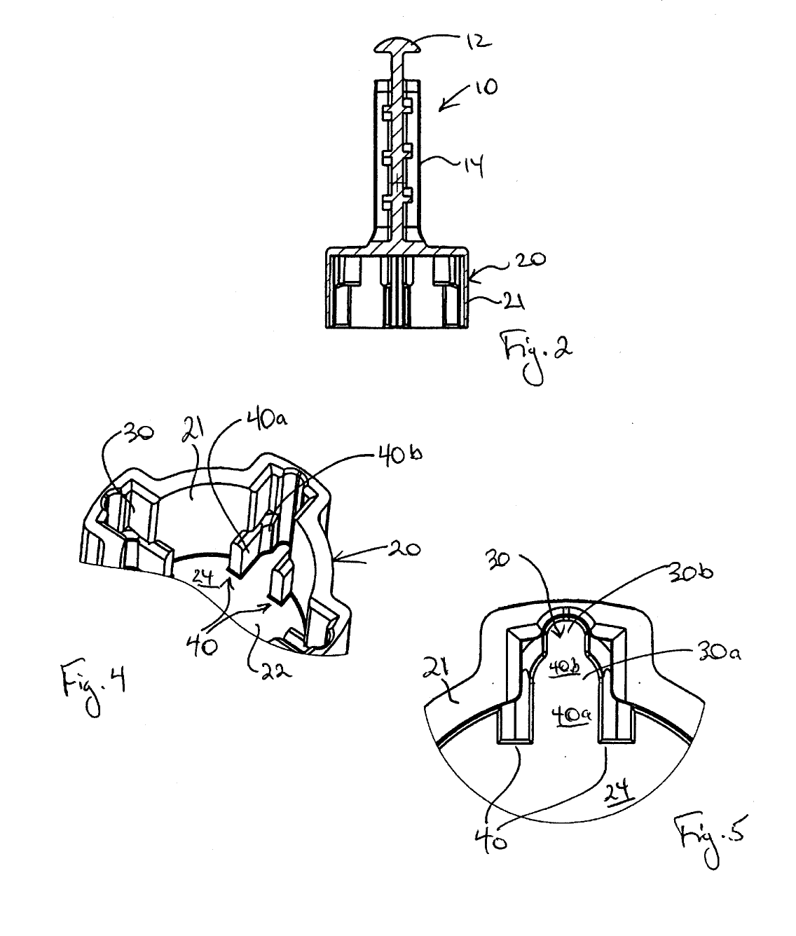

As illustrated in FIG. 1, in a preferred embodiment a tool 10 of the invention generally comprises a handle 12 attached to a stem 14 supporting a socket 20. The handle 12 may be provided with a contoured underside with finger indentations 16 for the user's comfort during use while wearing protective gloves.

Preferably the handle 12, stem 14 and socket 20 are integrally molded from a strong, rigid ABS plastic. However, the components of the tool may be integrally formed, or individually formed, from any suitable non-conductive material, preferably plastic. Suitable thicknesses and reinforcing structures such as ribs may be provided as required to impart structural integrity and torsional rigidity to the tool 10.

The interior of the socket 24 shown in FIG. 3, comprises a floor 22 and a sidewall 21. Within the interior of socket 20 are a plurality of recesses extending from the floor to the opening of the socket. A plurality of pinch projections associated with the recesses extend from the floor 22 of the socket 20 partway toward the opening of the socket and radially inwardly into a central portion 24 of the socket 20, thus forming second sets of recesses respectively underlying first sets of recesses. The first and second sets of recesses have different shapes or dimensions or both, allowing the socket 20 to compressively retain different configurations of caps, as described in detail below.

In particular, the sidewall 21 is configured with recesses 30 evenly spaced about the periphery of the sidewall 21 at 90° intervals. As illustrated in FIG. 5, each recess 30 has a generally rectangular section 30a projecting radially outwardly, generally centrally from the rectangular section. The rectangular section 30a extends from the open socket end of 40 to the opening of the socket 20. An arcuate portion 30b extends from the floor 22 to the opening end of the socket 20.

Extending axially from the floor 22 partially toward the opening of the socket 20, and from the rectangular section 30 into the open central portion 24 of the socket 20, is a pair of pinch projections 40. The pinch projections 40 are preferably generally parallel and preferably integrally molded with the socket 20. Each pinch projection 40 comprises a projecting section 40a projecting inwardly into the central portion 24 of the socket 20 and a peripheral arcuate section 40b. Thus, the recess 30 axially overlays (in bottom view) the rectangular and arcuate sections 40a, 40b.

FIGS. 6A, 6B, 7A, 7B, 8A, 8B and 9A, 9B illustrate various standard caps 2 used in rechargeable lead acid batteries for electric vehicles such as fork lift trucks, seated in the socket 20, and the various pinch points that retain the cap 2 lodged in the socket 20. It can be seen that the various configurations provided within the socket 24, between the recesses 30a, 30b defined in the peripheral wall of the socket 20, and the recesses 40a, 40b defined by the peripheral wall of the socket 20 and the pinch projections 40, accommodate all of the standard battery cap configurations shown. The finger grip tabs 4 of each battery cap 2 seat in the appropriate structure within the socket 24, allowing the user to rotate the cap 2 to its release point (typically one quarter turn). Each cap 2 remains lodged in the socket 24 by compressive forces exerted by the structures which contact the cap 2 and/or the finger grip tabs 4 of the cap 2.

In particular, in respect of the cap 2 shown in FIGS. 6A and 6B, the portion of finger tabs 4 projecting axially above the top of the cap 2 are seated in rectangular section 40a and arcuate section 40b, and compressively retained or “pinched” between pinch projections 40, as denoted by spans A, B, C, D in FIG. 6C.

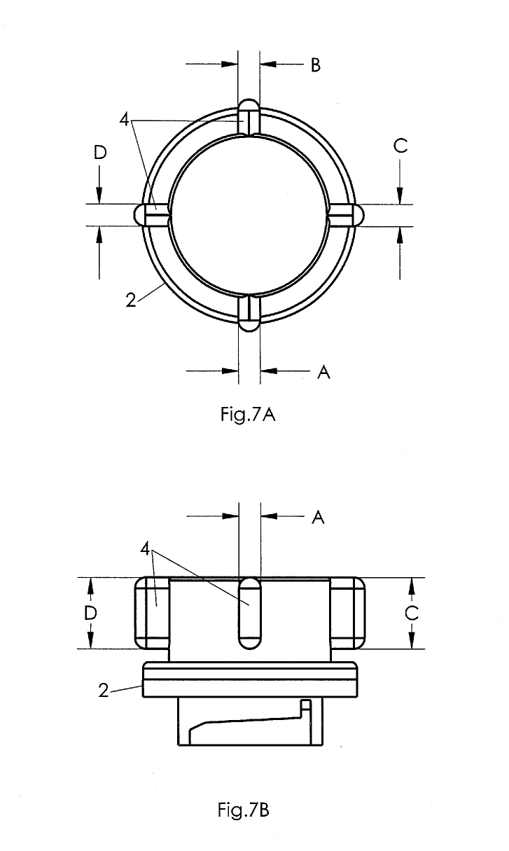

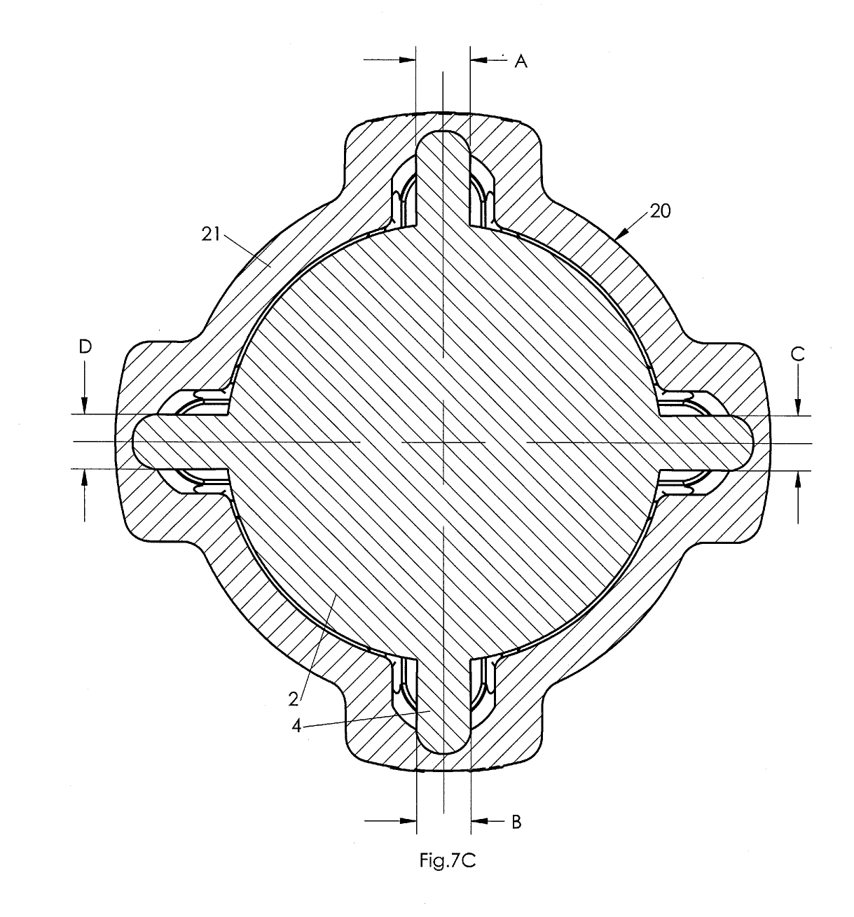

In respect of the cap 2 shown in FIGS. 7A and 7B, the finger tabs 4 are seated in arcuate section 30b, and compressively retained between the portions of the side wall of the cap forming arcuate sections 30b on opposite sides of the cap 2, as denoted by spans A, B, C, D in FIG. 7C.

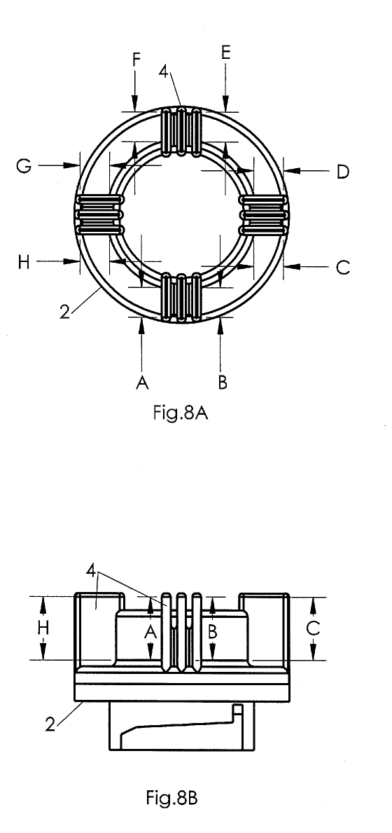

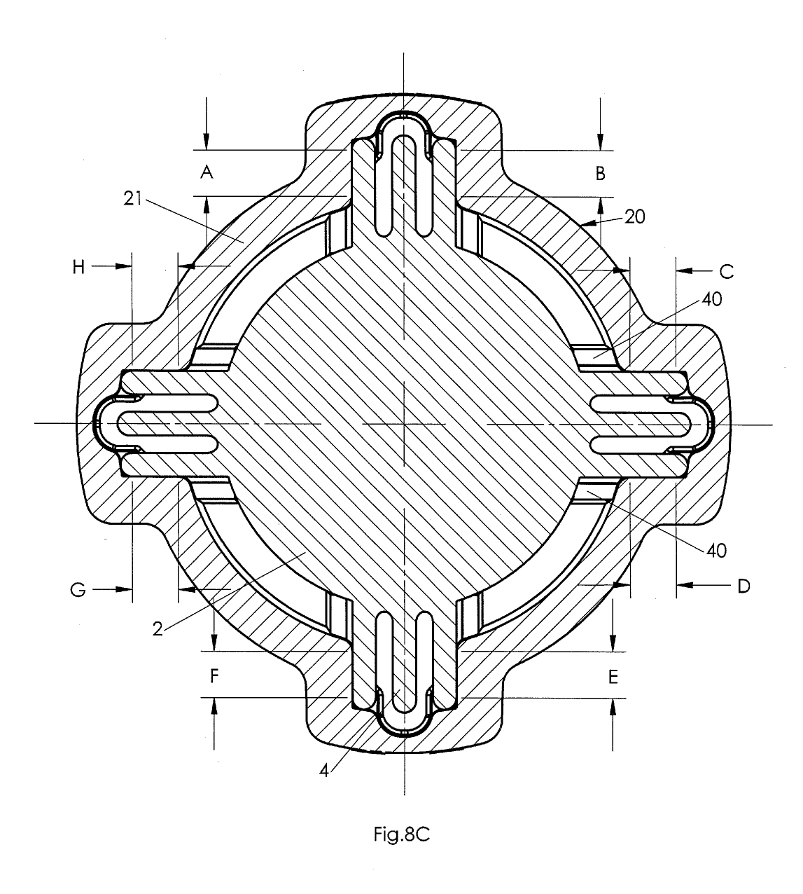

In respect of the cap 2 shown in FIGS. 8A and 8B, the finger tabs 4 are seated in recess 30, and compressively retained between the portions of the side wall of the cap 2 forming the sides of rectangular section 30a, as denoted by spans A, B, C, D, E, F, G, H in FIG. 8C.

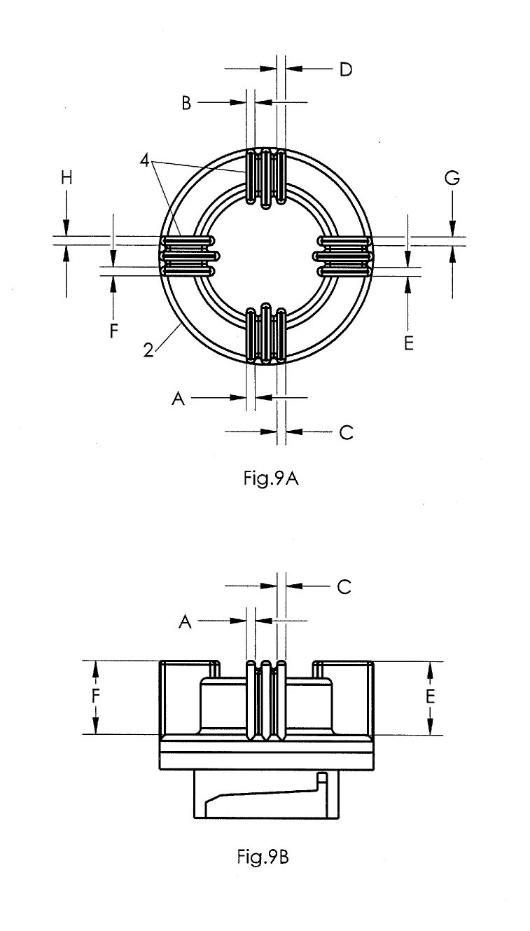

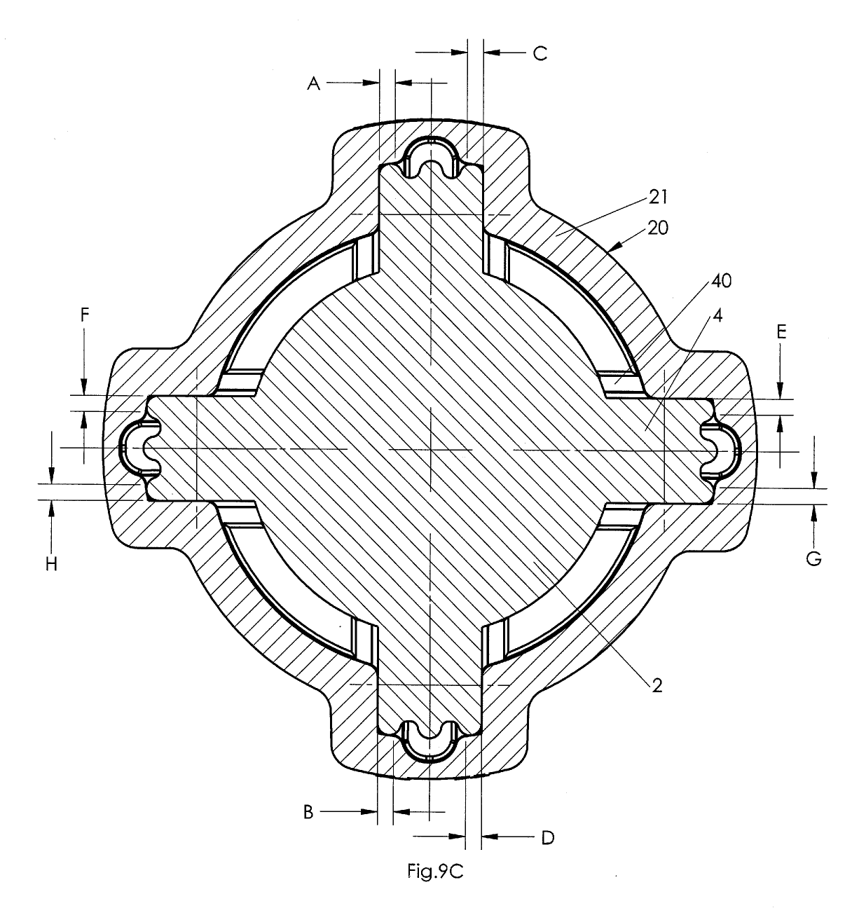

In respect of the cap 2 shown in FIGS. 9A and 9B, the finger tabs 4 are seated in rectangular section 30a, and compressively retained between the portions of the side wall forming the peripheral wall of the cap 2 within rectangular section 30a on opposite sides of the cap 2, as denoted by spans A, B, C, D, E, F, G, H in FIG. 9C.

The cap 2 thus remains lodged in the socket 20 of the tool 10 while the user refills the battery cell associated with the removed cap 2, and the cap 2 can then be returned and secured to the battery without ever removing the cap from the socket 20. Thus, the user's hands never need to approach the potentially corrosive liquids contained within the battery. Furthermore, rotation of each cap 2 is facilitated by the leverage provided by the “T” handle 12 of the tool 10.

Various embodiments of the present invention having been thus described in detail by way of example, it will be apparent to those skilled in the art that variations and modifications may be made without departing from the invention. The invention includes all such variations and modifications as fall within the scope of the appended claims.

We claim:

1. A tool for removing a cap from a battery cell, the cap having a sidewall and radially extending tabs, comprising:
a handle affixed to a socket, the socket comprising a plurality of recesses extending from the floor of the recesses to the opening of the socket,
a plurality of pinch projections associated with said recesses, said pinch projections extending from a floor of the socket partway toward an opening of the socket and into a central portion of the socket forming second sets of recesses respectively underlying first sets of recesses, the first and second sets of recesses having different shapes or dimensions or both,
whereby a plurality of different configurations of cap can be lodged and rotationally fixed within the socket to remove said cap from the battery cell.

2. The tool of claim 1 wherein the container comprises a lead acid battery containing a replenishable fluid.
